(19) United States
(12) Patent Application Publication
(10) Pub. No.: US 2006/0039674 A1
(43) Pub. Date: Feb. 23, 2006

(54) Image editing apparatus, method, and program

(75) Inventors: Fumihiro Sonoda, Kanagawa (JP); Hajime Araya, Kanagawa (JP); Takashi Hoshino, Kanagawa (JP); Takayuki Iida, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/208,748

(22) Filed: Aug. 23, 2005

(30) Foreign Application Priority Data
Aug. 23, 2004 (JP) 2004-242007

(51) Int. Cl. H04N 5/76

(52) U.S. Cl. 386/52; 386/55

(57) ABSTRACT

An image editing apparatus creates photo movies from frame images read out from a memory card. A file for the frame images stores frame classification information in relationship to the image data. An editing condition setup section reads out a scenario form from a HDD. The scenario form determines plural scene categories. The editing condition setup section assigns the frame images to the scene categories based on the frame classification information to complete a scenario. A photo movie creating section follows the scenario to create a photo movie. The scenario determines a special effect, BGM, and the like for each scene category, and all the frame images belonging to the same scene category are edited and processed as a group.

### BACKGROUND OF THE INVENTION

1. Field of the Invention

The present invention relates to an image editing apparatus, method, and program which create photo movies from plural still images.

2. Background Arts

It is a public knowledge that frame images (or still images) captured with a digital camera are sometimes edited and processed for creating pseudo moving images (hereinafter referred to as photo movies) which appear as if the things are moving (see, for example, the Japanese patent laid-open publication No. 10-200843 and “LiFE* with PhotoCinema” from Digitalstage inc., searched on Apr. 6, 2004, via the Internet, <URL: http://www.digitalstage.net/jp/product/life/index.html>). Frame image editing includes, for example, an electronic zooming process that crops and zooms in to a portion of a frame image, an electronic panning process that moves a segment frame from one end to the other end in a frame image to give a sense of view point move, and an image composite process that synthesizes a frame image with decorative images. These special effects (or simply, effects) can add movement, like moving images, to frame images.

The Japanese patent laid-open publication No. 10-200843 and the “LiFE* with PhotoCinema” disclose image editing software for such edit and process to the photo movies. Unfortunately, these image editing software require the users to manually specify a playback sequence of plural frame images or manually select the kind of special effects for each of the frame images, and the editing operation will become complicated. On the other hand, the image editing software of the “LiFE* with PhotoCinema” offers an automatic mode, where the photo movies are automatically created only by selecting the frame images to be used. The editing operation could be very easy in this automatic mode because all edit conditions, except for selecting the frame images, are automatically set up by a computer.

In this automatic mode, however, the software detects no differences between the selected frame images, and the frame images are not always assigned to appropriate scenes in a photo movie. For example, two unrelated frame images may be combined together, or the frame images may be placed at random in the photo movie regardless of their captured order. Thus created photo movie would hardly reproduce (or tell) the intended story.

The photo movie is usually made from the plural still images of a single event. Such an event has its own story (flow of the event) just like the travel takes a course of preparation, an outward trip, sightseeing in the destination, and a return trip, or just like an athletic festival has an opening ceremony, morning athletic events, a lunch break, afternoon athletic events, and a closing ceremony. Proper reproduction of the story is a critical factor for creating well-made photo movies.

### SUMMARY OF THE INVENTION

In view of the foregoing, an object of the present invention is to provide an image editing apparatus, method, and program which can create well-made photo movies with simple operation.

To achieve the above object and other objects of the present invention, the image editing apparatus includes a frame classification information reader for reading out frame classification information from a storage medium in order to assign frame images captured with a digital camera to plural scene categories contained in a photo movie, and an image processor for assigning each of the frame images to one of the plural scene categories based on the frame classification information to create the photo movie.

The image editing apparatus further includes a memory for storing plural scenario file forms each of which determines the plural scene categories in the photo movie. The frame classification information contains scenario specification information which specifies one of the scenario files, and the image processor identifies the specified scenario file form based on the scenario specification information.

The image processor assigns the frame images to the plural scene categories by embedding ID numbers of the frame images into the scenario file form based on the frame classification information.

The image editing method and program of the present invention include a step of reading out frame classification information from a storage medium in order to assign frame images captured with a digital camera to plural scene categories contained in a photo movie, and a step of creating photo movies by assigning each of the frame images to one of the plural scene categories.

The step of creating photo movies further includes a step of identifying one of scenario file forms, which determines said plural scene categories in said photo movie, based on the frame classification information, and a step of embedding ID numbers of the frame images into the scenario file form based on the frame classification information.

According to the image editing apparatus, method, and program of the present invention, the frame classification information, which is given to each of the frame images as material for a photo movie, for assigning each of the frame images to one of plural scene categories in the photo movie will be read out from the storage medium. The photo movie is created by assigning each of the frame images to one of the plural scene categories based on the frame classification information. Well-made photo movies can thereby be created with simple operation.

### BRIEF DESCRIPTION OF THE DRAWINGS

For more complete understanding of the present invention, and the advantage thereof, reference is now made to the following descriptions taken in conjunction with the accompanying drawings, in which:

FIG. 1 is a block diagram of an image editing apparatus;

FIGS. 2A to 2C are explanatory views of special effects applied to photo movies;

FIG. 3 is an explanatory view of a scenario file for the photo movies;

FIG. 4 is a block diagram showing an electrical structure of a digital still camera;

FIGS. 5A and 5B are explanatory views of a scenario selection screen and a through image display screen;

FIG. 6 is an explanatory view showing an example classification of frame images into scene categories of athletic festival;

FIG. 7 is an explanatory view showing an example classification of frame images into scene categories of travel;

FIG. 8 is a flow chart of an image capturing procedure in a frame classification mode;

FIG. 9 is a flow chart of a photo movie creation procedure;

FIG. 10 is an explanatory view of the scene category with a hierarchical structure;

FIGS. 11A and 11B are explanatory views showing another storage method for frame classification information; and

FIG. 12 is an explanatory view showing an example connection to external devices such as mobile terminals.

### DESCRIPTION OF THE PREFFERED EMBODIMENTS

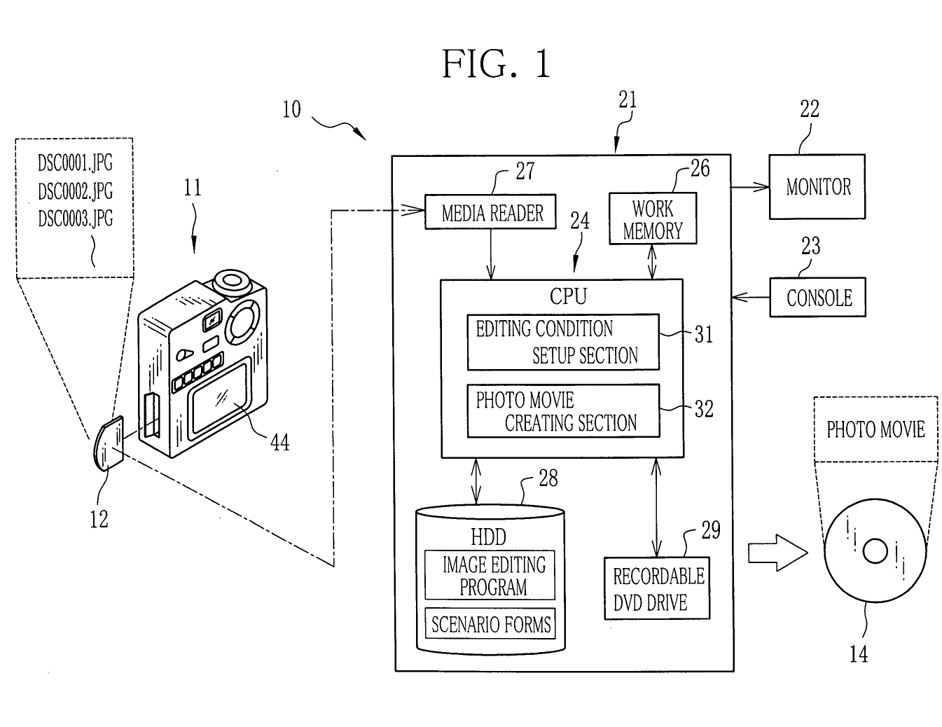

Referring to FIG. 1, an image editing apparatus 10 loads image data of the still images (or frame images) captured with a digital still camera 11 from a memory card 12, and then creates a photo movie from the frame images. The image editing apparatus 10 is installed at, for example, DPE shops and drag stores (or convenience stores) which offer a photo printing service and a digital data writing service on any recording medium, and this apparatus is operated by a customer who brings the memory card 12 or by a shop clerk. The image editing apparatus 10 records a created photo movie on a DVD medium 14, which is then provided to the customer.

The image editing apparatus 10 is composed of a main unit 21, a monitor 22, and a console 23. The main unit 21 is, for example, a general personal computer or work station installed with an image editing program. The main unit 21 includes a CPU 24, a work memory 26, a media reader 27, a hard disk drive (HDD) 28, and a recordable DVD drive 29. The CPU 24 controls over every component of the apparatus in accordance with an operating system.

The media reader 27 reads out data from the memory card 12 to load the frame images as material for a photo movie. The monitor 22 displays an operation screen of the image editing program as well as the frame images read out. The console 23, which is an operational command input device to the image editing apparatus 10, is composed of a mouse, a keyboard, and some such.

The recordable DVD drive 29 writes data on the DVD medium 14. However, the storage medium is not limited to a DVD, and any existing storage medium such as a CD or any next-generation storage medium such as Blu-ray (registered trademark) may also be used. Alternatively, the apparatus can be configured to handle a variety of storage media so as to meet the customers' requirements.

The CPU 24 downloads the image editing program into the work memory 26 and executes the editing processes described in the program. The CPU 24 will thereby function as an edit condition setup section 31 and a photo movie creating section 32.

The HDD 28 contains the operating system and the image editing program, which are executed by the CPU 24. The HDD 28 also contains various kinds of accompanying data used in the image editing program. The accompanying data includes later described scenario files of the photo movies and decorative images to be synthesized with the frame images. The decorative images would be a mask image to cover unnecessary portions of a targeted image and a template image that has decorative illustrations and a framed area for insertion of the targeted image. The decorative images can add some flavor to the photo movies by decorating backgrounds or specific spots of the frame images.

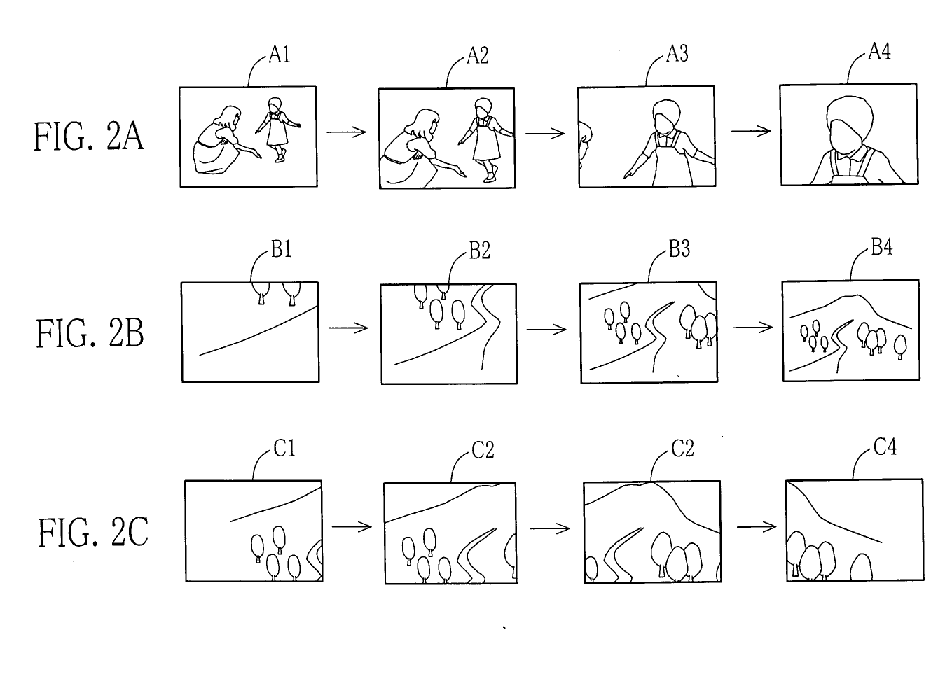

As shown in FIGS. 2A to 2C, the special effects such as an electronic zooming process and an electronic panning process are applied to the frame images in the photo movie creation. FIG. 2A shows a scene A which begins with a frame A1 of a parent and a child, proceeds to a frame A2 and a frame A3 of the child's face zoomed up gradually, then reaches a frame A4 the close-up shot of the child's face. The scene A are created through the electronic zooming process by placing a zoom point at a certain part of the original image (the frame A1), cropping out the partial images of different magnification (the frames A2 to A4), and coupling these images together.

FIG. 2B shows a scene B which begins with a frame B1 of a ground surface and a road, then gradually zooms out to reach a frame B4 of a long distance view of a mountain which lies ahead the road. The scene B are created, in the same process as the scene A, by placing a zoom point at a certain part of an original still image (the frame B4), cropping out the partial images of different magnification (the frames B1 to B3), and coupling the images together. Since the scene B depicts the zoom-out from the zoom point, unlike the scene A which depicts the zoom-in to the zoom point, the first frame B1 has the highest magnification while the last frame B4 has the same magnification as the original image.

FIG. 2C shows a scene C which gives a sense of a camera panned horizontally to offer a panoramic effect. The scene C begins with a frame C1 showing the left foot of a mountain as the main subject, proceeds to a frame C2 and a frame C3 showing the mountain in the center of a screen, then reaches a frame C4 showing the right foot of the mountain. The scene C are created by cropping some parts of an original still image, which captures a long distance view of the whole mountain, with moving a cropping point from left to right, and then coupling the cropped images (the frames C1 to C4) together. In the above embodiments, every scene is comprised of four frames for the sake of simplicity, but in reality each scene contains a significant number of frames displayed at a frame rate of, for example, thirty frames per second. The plural scenes with the special effects applied thereto are joined together to create a photo movie.

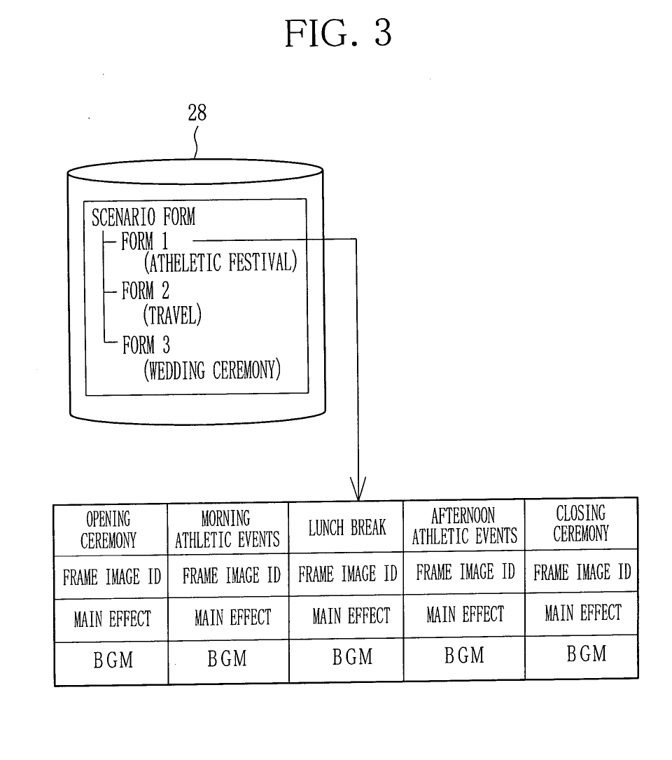

The edit conditions for the photo movies are written in the scenario file, for example. The scenario file defines the special effects applied to each of the frame images along a time stamp of the frame. The HDD 28 contains forms of various scenarios (i.e. scenario forms) that define the basic edit conditions for each of the events such as an athletic festival, travel, and a wedding ceremony. As shown in FIG. 3, the scenario file contains ID numbers of the material frame images, type of the special effects, BGM, and decorative images used as background to decorate the frame images.

The scenario file carries scene configuration information which defines major scenes of a photo movie. In the scenario file of the athletic festival, for example, the photo movie is divided into five major scenes as “opening ceremony”, “morning athletic events”, “lunch break”, “afternoon athletic events”, and “closing ceremony”. And scene categories corresponding to these major scenes are defined as scene configuration information.

The ID numbers of the frame images to be used in each scenes are respectively associated with one of the scene categories. Because the frame images are classified into the scene categories, any unexpected scenes with unrelated frame images such as, for example, the opening ceremony and the lunch break are never created, and each scene will have appropriate frame images.

The scenario forms determine in advance a main effect and BGM for each scene category. As for the scene category of, for example, the “opening ceremony” which is supposed to have the frame image of the whole festival site, the main effect is determined to the panning process that can show the entire festival site and convey the excitement of the site. And cheerful music is used as the BGM. As for the scene categories of both “morning athletic events” and “afternoon athletic events”, the main effect is determined to the zooming process to focus on a specific athlete (the child of a photographer, for example) in a game such as a tug-of-war or a relay race. One exemplary method to place the zoom point on the specific person would be face extraction through an image analysis technique. The BGM of these scenes will be up-tempo music to give punch to the scenes. By determining the main effect and BGM for each scene category in this manner, the created photo movie comes to reproduces the story of the event.

The edit condition setup section 31 shown in FIG. 1 retrieves from the HDD 28 a specified scenario form, then classifies plural frame images, which have been imported through the media reader 27, to the scene categories in the retrieved scenario form. A scenario form selecting operation and a frame image classifying operation are made based on classification information (or frame classification information) added to the frame images as described later. If no classification information is added to a frame image, these operations are made according to instructions entered by a user. The edit conditions are set up in this way to form a scenario file, which the photo movie creating section 32 follows to create a photo movie.

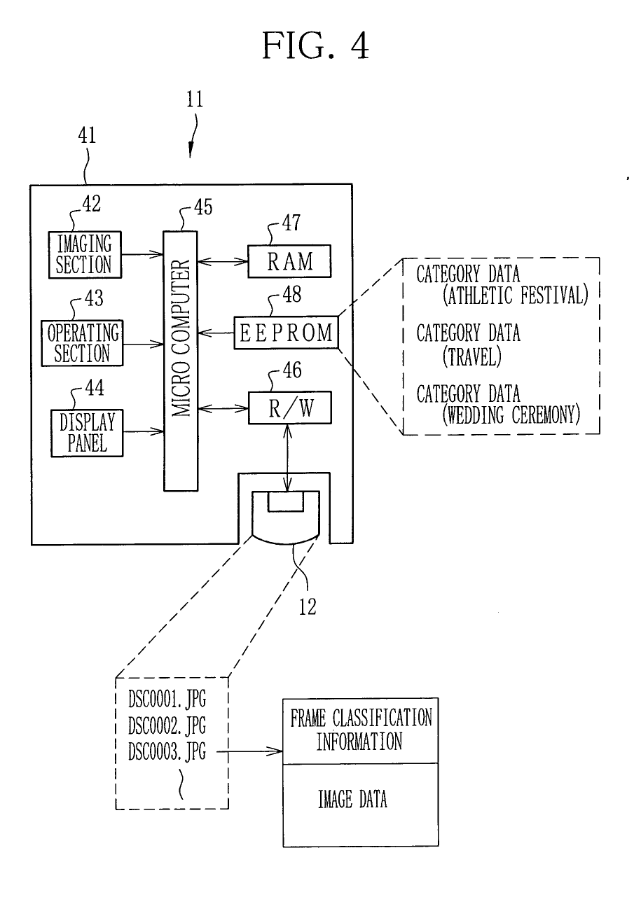

Referring to FIG. 4, the digital still camera 11 equips the camera body 41 with an imaging section 42 composed of a taking lens and a CCD image sensor, an operating section 43 composed of such members as a multi-direction key for moving cursors to select various items, a mode selection switch, and a shutter button, a display panel 44 (such as an LCD panel) for playing back captured images and a operation screen, and an R/W circuit 46 for entering the memory card 12 to read and write the image data. The display panel 44 will also function as an electronic view finder to display live images (or through images) in real time with image capturing through the imaging section 42.

Every component of the digital still camera 11 is controlled by a microcomputer 45. The microcomputer 45 is connected not only to the imaging section 42, the operating section 43, the display panel 44, and the R/W circuit 46 but also to an RAM 47 and an EEPROM 48. The RAM 47 is used as a temporary storage site for captured images and as a work memory. The EEPROM 48 stores a camera control program and category data determined according to the above scenario forms.

Anticipating that the users intend to create the photo movies from the captured frame images, the digital still camera 11 offers a frame classification mode, as well as the standard capturing mode, for classifying the captured frame images into the plural scene categories defined in the scenario files. When a certain scene category is specified in the frame classification mode, the digital still camera 11 then stores the image data of the captured frame image in the memory card 12 in relationship to the frame classification information representing the specified scene category. The image editing apparatus 10 identifies the specified scene category and assigns the frame image thereto based on the frame classification information.

The frame classification information is stored in the image file as, for example, the supplemental information of the image data (DSC000X.JPG). An exemplary storage region for the frame classification information would be a tag field defined by the EXIF standard, a common file format of digital still cameras. Nonetheless the frame classification information need not be stored in the same file as the image data, as long as they are associated with each other. For example, a separately created file for indicating a correspondence between the image file name and the frame classification information may be stored in the memory card 12 together with the image file.

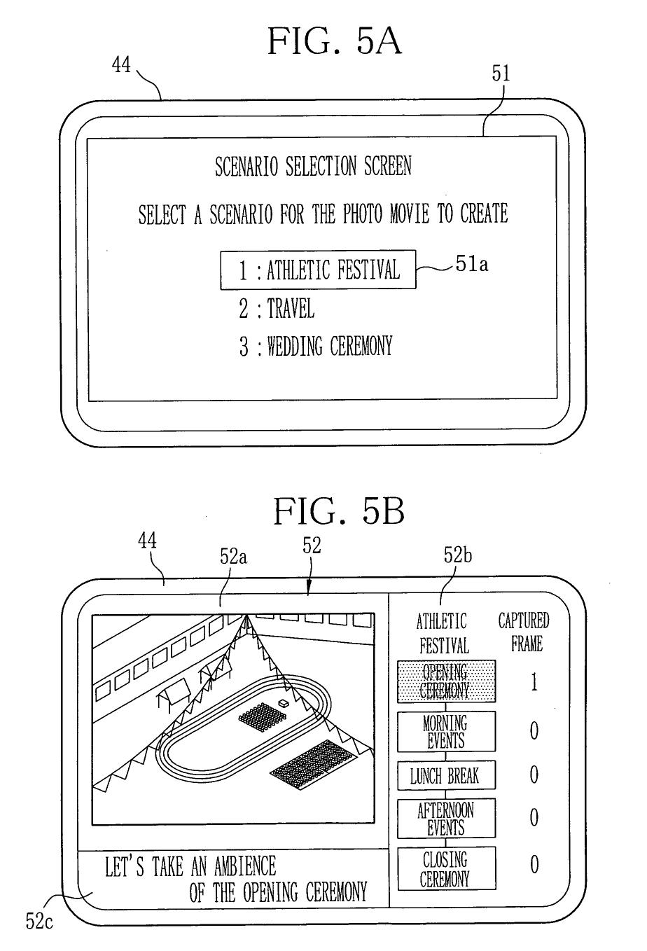

As shown in FIG. 5, when the frame classification mode is selected, the display panel 44 firstly displays the scenario selection screen 51 depicted in FIG. 5A. The scenario selection screen 51 exhibits a message as “Select a scenario for the photo movie to create”and, below the message, a list of the category data pre-stored in the EEPROM 48. The category data, which is the scene configuration data extracted from the scenario forms in the HDD 28 of the image forming apparatus 10, will be “athletic festival”, “traveling”, and “wedding ceremony” to correspond to the scenario forms. Since the category data corresponds to each of the scenario forms, specifying one of the category data leads to select a certain photo movie scenario. The users are able to select a scenario by pointing a cursor 51a to intended category data upon operation of the operating section 43.

The through image display screen 52 depicted in FIG. 5B will show up when the category data is specified in the scenario selection screen 51. In the frame classification mode, the through image display screen 52 is divided into three areas, an image display area 52a for displaying the through images, a category display area 52b for displaying the specified category data beside the image display area, and a message display area 52c for instructing the users an appropriate frame image to capture below the image display area 52a.

Assuming that, for example, the category data of the “athletic festival” is specified, the category display area 52b displays the scene categories 56a to 56e, i.e. “opening ceremony”, “morning athletic events”, “lunch break”, “afternoon athletic events”, and “closing ceremony”.

The user should select one of the scene categories 56a to 56e using the multi-direction key before executing the image capturing operation. As for the captured frame image with a scene category selected in advance, its image data is stored in relationship to the frame classification information that represents the specified scene category. For example, if the scene category 56a is selected as shown in FIG. 5B, the selected category is grayed out to provide clear discrimination from the other scene categories. When captured in this state, the frame image is associated with the frame classification information which represents the scene category 56a and stored.

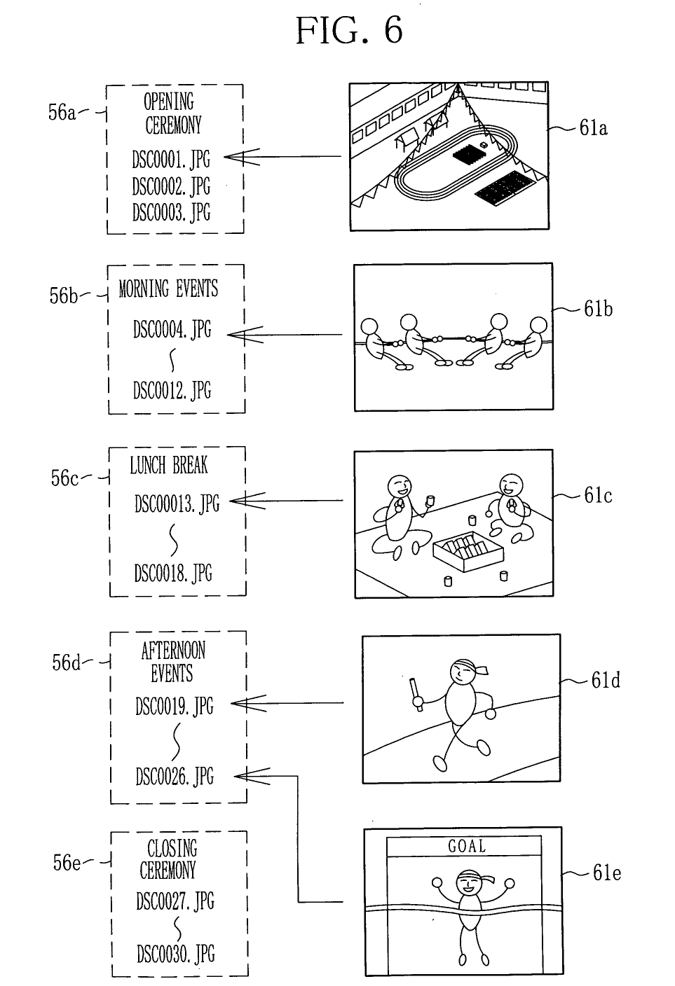

Thereby, as shown in FIG. 6, the digital still camera 11 can classify the frame image 61a of the opening ceremony into the scene category 56a of the “opening ceremony”, also the frame image 61b of a tag-of-war in the morning into the scene category 56b of the “morning athletic events”, the frame image 61c of the lunch break into the scene category 56c of the “lunch break”, the frame images 61d, 61e of a relay race in the afternoon into the scene category 56d of the “afternoon athletic events”, and a frame image of, for example” a scoreboard (not shown) into the scene category 56e of the “closing ceremony” so as to present the result of the festival.

Although this embodiment uses the multi-direction key for the scenario selecting operation and the scene category specifying operation, it is possible to incorporate a touch screen as the display panel 44 so that touching the screen carries out these operations.

The category display area 52b displays a list of the scene categories 56a to 56e, which are aligned along a time line in a flow chart. This area enables the user to perceive in advance the overall scene configurations of the photo movie to create. The user can therefore easily imagine the necessary frame images for the photo movie, and hardly fails to capture any necessary frame images (the opening ceremony or the lunch break, for example).

Next to the scene categories 56a to 56e, number of the captured frame images is displayed for each scene category. In FIG. 5B, only one frame image has been captured and it belongs to the scene category 56a. Displaying the number of captured frame images for each scene category enables the users to realize overage or shortage of the frame images for each category. The overage and shortage would be easily realized because the category display area 52b appears on the same window as the image display area 52a.

The message display area 52c displays messages to indicate the appropriate image content for the specified scene category. If the scene category 56a of “opening ceremony” is specified, the message on the display area would be, for example, “Let's take an ambience of the opening ceremony”. Obviously, more detailed message such as “Let's take the moment of athlete's oath in the opening ceremony” or “Let's take the profiles of the athletes in lines” may be displayed alternatively.

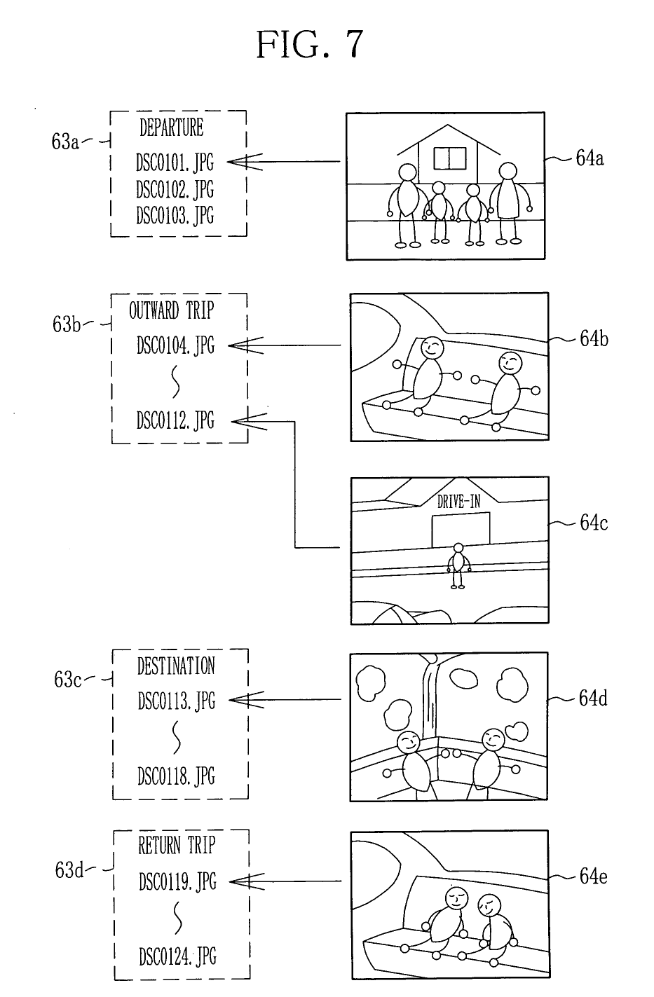

FIG. 7 shows an example classification of frame images according to the scenario of travel. The scenario of travel has the scene categories 63a to 63d of, for example, “departure”, “outward trip”, “destination”, and “return trip”. The image of a family in front of the house at departure should be captured after the scene category 63a of “departure” is specified. Thus, the captured frame image 64a is associated with the frame classification information which represents the scene category 63a and stored in the memory card 12.

In the same manner, both the frame image 64b of the children in the car heading to the destination and the frame image 64c of a drive-in on the way are classified into the scene category 63b of the “outward trip”. And the frame image 64d of the children playing at the destination is classified into the scene category 63c of “destination” while the frame image 64e of the children sleeping in the car going home is classified into the scene category 63d of “return trip”. Much like the above mentioned scenario of “athletic festival”, the scenario of “traveling” defines a main effect and BGM in each of its scene categories.

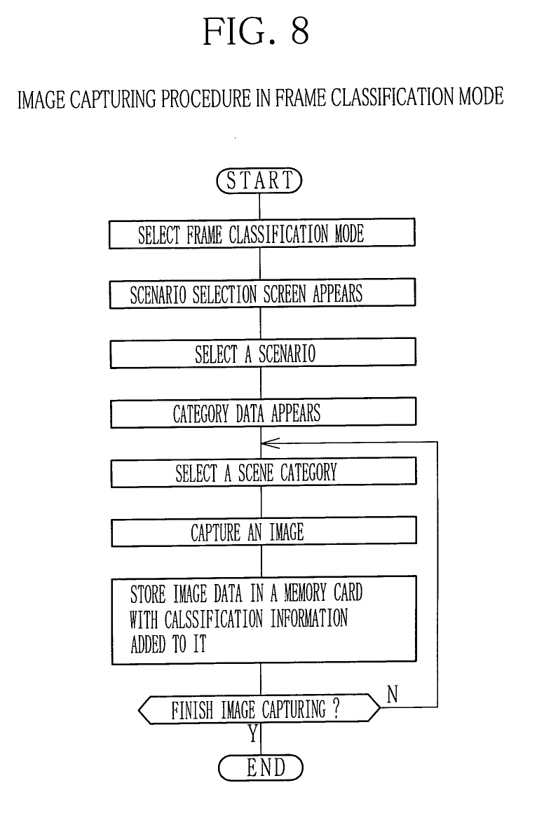

The operation of the above construction is now explained. When capturing the frame images as material for a photo movie, the user selects the frame classification mode on the digital still camera 11 as shown in FIG. 8. Once the frame classification mode is selected, the display panel 44 displays the scenario selection screen 51, on which the user would specify the scenario of “athletic festival” when capturing the images of an athletic festival.

Then the through image display screen 52 takes the place of the scenario selection screen 51 on the display panel 44, listing the scene categories 56a to 56e of the specified “athletic festival” scenario in the category display area 52b. The user selects one of these scene categories and captures an image. The captured frame image is put in an image file together with the frame classification information which corresponds to the selected scene category, then stored in the memory card 12.

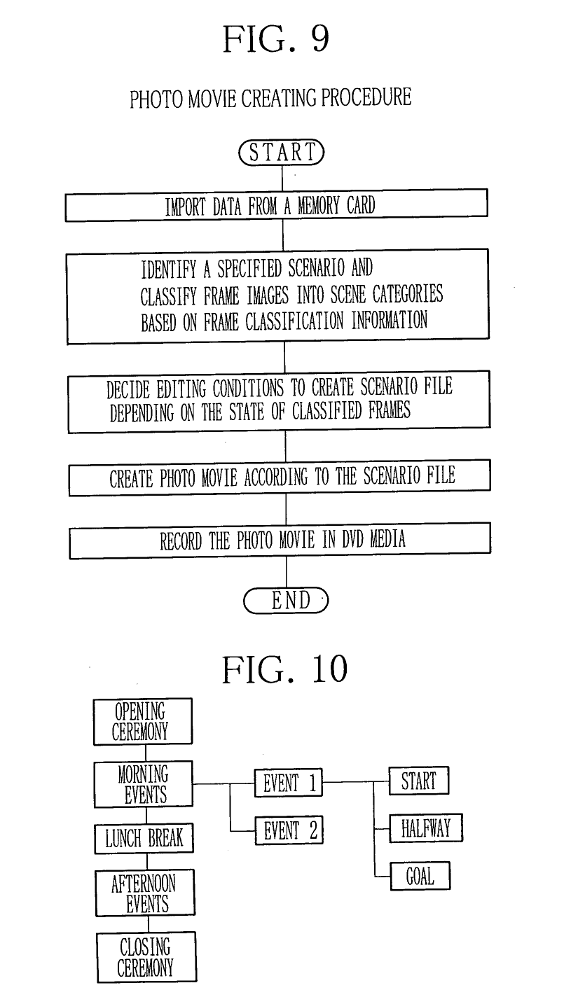

To create the photo movie from the captured frame images, the user will bring the memory card 12 to a photofinisher and ask for a photo movie. As shown in FIG. 9, an operator of the image editing apparatus 10 places the memory card 12 in the media reader 27 to download the image file into the main unit 21. Once the image file is loaded, the edit condition setup section 31 identifies the specified scenario based on the frame classification information in the image file and reads out a scenario form corresponding to the specified scenario from the HDD 28. The frame images are respectively assigned to one of the scene categories of the scenario form to produce a scenario file. The operator of the image editing apparatus 10 makes some changes to the given edit conditions, where needed, to determine an eventual edit conditions.

When the edit conditions are determined, the photo movie creating section 32 follows the scenario file to create the photo movie. The photo movie will be edited on a scene category basis. Since the frame images have been classified into the appropriate scene categories according to their content, there is no chance of unrelated frame images appearing in the same scene nor related frame images appearing in the separate scenes. The scenes are arranged along a time line, and the main effect and the BGM are selected according to the scene categories, each scene will have its own characteristic which gives a dynamic scene change. The photo movie edited and created in this way can reproduce the story of the event. In addition, the frame images are automatically classified according to the frame classification information, and therefore the operator's work will be simplified.

In this type of service where the photofinishers create the photo movies upon order of the customers (i.e. photographers), reflecting the photographers' intention in the photo movie is a critical factor for enhancing the commercial value of the product. However, it is very difficult for the photofinishers to comprehend such intention when classifying the frame images. When using the above digital still camera 11, the photographer himself is going to classify the frame images. Therefore, the frame images are appropriately classified and, as a result, the quality of photo movie creation service from the photofinishers will be improved.

The present invention can also be effective when the photographer operates the image editing apparatus. The photographer will enjoy, in this case, the merit of less demanding editing operation because the frame images were already classified at the time of image capture.

In the above embodiment, the category data is consisted only of the scene categories in the same hierarchical level. The scene categories may alternatively take a multi hierarchical structure, as shown in FIG. 10 for example, in which the scene category 56b of “morning athletic events” subordinates the scene categories of “athletic event 1” and “athletic event 2”, then the “athletic event 1” subordinates the scene categories of “start”, “halfway”, and “goal”. This detailed classification enables a still finer edit, leading to improve the quality of the photo movie.

The edit conditions in the above embodiment regulate the scenario selection and the frame image classification into the scene categories. Other edit condition may additionally be set up for frame image specification as some climax scenes of a photo movie. Taking the frame images of the “athletic festival” in FIG. 6 as an example, one of such climax scenes of the photo movie would be the frame image 61e, which captures the goal of a race. By specifying the frame image 61e as the climax scene and displaying it longer and more times than other frame images, the created photo movie can be further expressive.

The frame images of climax scenes may be specified by any techniques such as, for example, a dedicated specification button or check box displayed on the operation screen in the display panel 44, or a specification button provided as a part of the operating section 43 on the main unit 21. The specification may be made at the time of image capture or after reading out the captured images from the memory card 12.

As well as the climax scenes, the frame images may be specified as any specific scenes such as the opening scene, the title scene, or the ending scene of a photo movie. In this case, the specified frame images will be inserted in the scenes regardless of the image capturing order. It is preferable to exhibit the date of the event, together with the title of a photo movie, to the opening scene and the title scene.

In the above embodiment, the scenario forms determine the main effect in each scene category. Additional special effects should be selected upon observation of the frame images. For example, group photos should be edited by the zooming and panning processes so that the panning and zooming in to each person's face is followed by the zooming out to the whole group image. And snap shots will be edited mainly by the zooming process, with little use of the panning process, because the snap shots tend to contain limited photographic subjects to look at.

The family photo such as the frame image 64a in FIG. 7 is usually captured by a father or a mother, and most of the case the father and mother take turns to capture two images of similar content. If this two similar images are given to the zooming process to focus on each photographed person, the children will appear very often. In this particular case, the image analysis technique should be incorporated to determine the similarity of these frame images. Then the zooming process is applied to all the photographed person in the former images while the zooming process in the later image is applied only to the people not showing in the former image (either the father or mother in this embodiment).

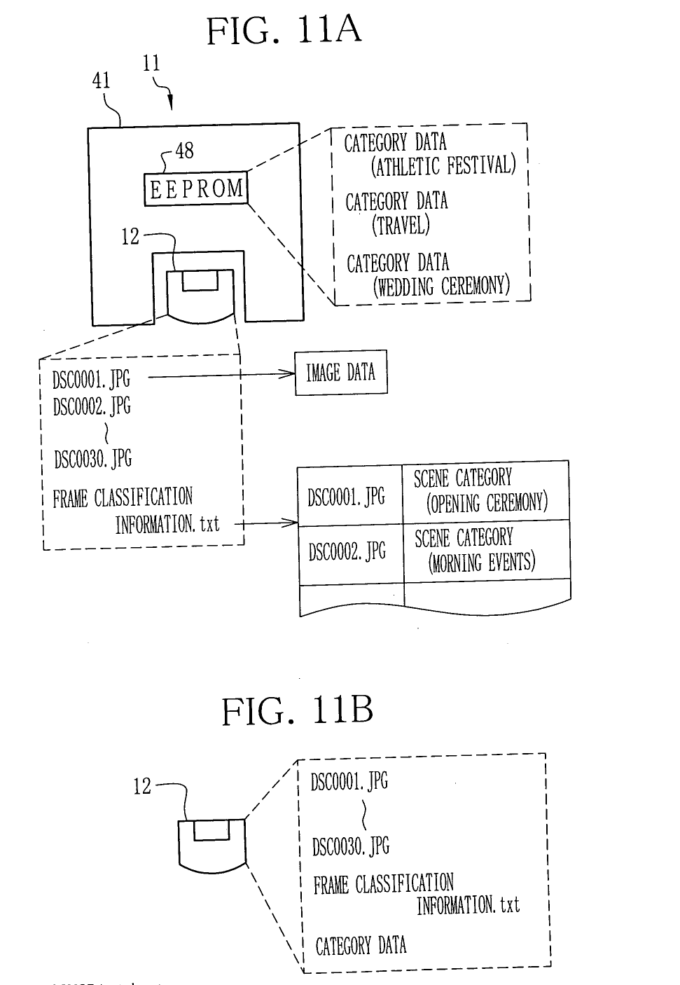

In the above embodiment, the frame classification information and the image data are stored together in the same file. But the two need only be associated with each other and do not have to be stored in the same file. For example, the frame classification information and the image data can be stored in the separate files (the jpg and the txt files) as shown in FIG. 11A. In this case, one text file is created as a frame classification information file which stores plural pieces of the frame classification information (i.e. scene categories) corresponding the image data. Thereby, the image editing apparatus should only access to the frame classification information file, not to the plural pieces of image data, to read out the frame classification information for any intended image data. Further, there is no need to modify the file format of usual image files (the EXIF format, for example) if the frame classification information and the image data are separately stored.

It is also possible, as shown in FIG. 11B, to store category data selected at the time of image capture as well as the image data and the frame classification information. In this case, the category data is read out from the EEPROM 48 and stored in the memory card 12. The category data carried in the digital still camera 11 must correspond to the scenario forms in the image editing apparatus 10, and it is not desirable that only the scenario forms are updated. By storing the category data in the memory card 12, on the other hand, the image editing apparatus 10 is able to check the correspondence between the category data and the scenario form.

Alternatively, an updated version of the category data is stored in the memory card 12 every time the scenario forms are updated in the image forming apparatus 10, so that the digital still camera 11 can update the category data in the EEPROM 48 when such a memory card is loaded.

In the above embodiment, the image editing apparatus is placed at the DPE shops or the like. However, any personal computers (PC) can be the image editing apparatus when installed with the image editing program of the present invention. The digital still camera can also work as the image editing apparatus if incorporates the image editing program.

Although the above embodiment uses the digital still camera, any mobile terminals with a built-in camera, such as camera cellular phones, may be used. It is further possible to use video cameras with a still image capturing feature.

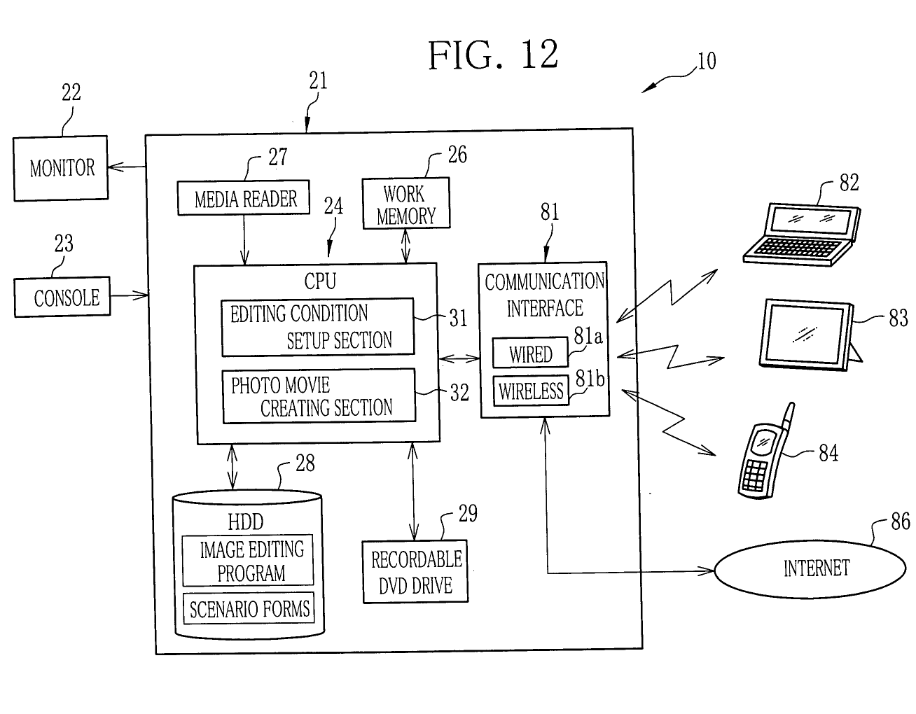

The output destination of the photo movies is not limited to the storage medium such as a DVD. If the image editing apparatus is provided with a communication interface 81 as shown in FIG. 12, the photo movies can be output through the communication interface 81 to a variety of mobile terminals such as a PDA (personal digital assistance) 82, a portable TV 83 equipped with a hard disk drive or a memory, or a cellular phone 84. It is preferable to provide a wired interface 81a and a wireless interface 81b as the communication interface 81 so that the wireless data transmission can be made.

The communication interface 81 may be used to import the image data for the photo movies from the variety of mobile terminals. The communication interface 81 may also be connected with such a communication network as an internet 86 in order to deliver the photo movies to, and import the material image data from the users' terminals via the communication network.

As described so far, the present invention is not to be limited to the above embodiments, and all matter contained herein is illustrative and does not limit the scope of the present invention. Thus, obvious modifications may be made within the spirit and scope of the appended claims.

What is claimed is:

1. An image editing apparatus for creating a photo movie by editing plural frame images read out from a storage medium, comprising:
a frame classification information reader for reading out frame classification information from said storage medium, said frame classification information being provided to each of said frame images for assignment to one of plural scene categories in said photo movie; and
an image processor for assigning each of said frame images to one of said plural scene categories based on said frame classification information to create said photo movie.

2. An image editing apparatus as claimed in claim 1, further comprising:
a memory for storing plural scenario file forms each of which determines said plural scene categories in said photo movie,
wherein said frame classification information contains scenario specification information which specifies one of said plural scenario file forms, and said image processor identifies said specified scenario file form based on said scenario specification information.

3. An image editing apparatus as claimed in claim 2, wherein said image processor assigns each of said frame images to one of said plural scene categories by embedding ID numbers of said frame images into said scenario file form based on said frame classification information.

4. An image editing apparatus as claimed in claim 1, further comprising:
a wired communication interface for outputting said photo movie to mobile terminals.

5. An image editing apparatus as claimed in claim 1, further comprising:
a wireless communication interface for outputting said photo movie to mobile terminals.

6. An image editing method for creating a photo movie by editing plural frame images read out from a storage medium, comprising the steps of:
(a) reading out frame classification information from said storage medium, said frame classification information being provided to said frame images for assigning each of said frame image to one of plural scene categories in said photo movie; and
(b) assigning each of said frame images to one of said plural scene categories based on said frame classification information to create said photo movie.

7. An image editing method as claimed in claim 6, wherein said step (b) further comprising the step of:
identifying one of scenario file forms, which determines said plural scene categories in said photo movie, based on said frame classification information.

8. An image editing method as claimed in claim 7, wherein said step (b) further comprising the step of:
embedding ID numbers of said frame images into said scenario file form based on said frame classification information.

9. An image editing program for operating a computer to perform an image editing process to create a photo movie by editing plural frame images read out from a storage medium, comprising the steps of:
(a) reading out frame classification information from said storage medium, said frame classification information being provided to said frame images for assigning each of said frame images to one of plural scene categories in said photo movie; and
(b) assigning each of said frame images to one of said plural scene categories based on said frame classification information to create said photo movie.

10. An image editing method as claimed in claim 9, wherein said step (b) further comprising the step of:
identifying one of scenario file forms, which determines said plural scene categories in said photo movie, based on said frame classification information.

11. An image editing method as claimed in claim 10, wherein said step (b) further comprising the step of:
embedding ID numbers of said frame images into said scenario file form based on said frame classification information.
